(19) United States
(12) Patent Application Publication
(10) Pub. No.: US 2018/0012149 A1
(43) Pub. Date: Jan. 11, 2018

(54) System and Method to Facilitate Parking Transactions

(71) Applicant: Meena Miriam Yust, Wilmette, IL (US)

(72) Inventor: Meena Miriam Yust, Wilmette, IL (US)

(21) Appl. No.: 15/641,038

(22) Filed: Jul. 3, 2017

Related U.S. Application Data
(60) Provisional application No. 62/493,643, filed on Jul. 11, 2016.

(51) Int. Cl. G06Q 10/02; G08G 1/14; G01C 21/36; G06Q 50/30; G06Q 50/00; G06Q 20/28; G06Q 20/34; G06Q 30/02

(52) U.S. Cl. CPC G06Q 10/02; G01C 21/3676; G08G 1/149; G06Q 50/30; G08G 1/144; G01C 21/362; G06Q 20/28; G06Q 20/34; G06Q 30/0206; G06Q 50/01; G06Q 30/0226

(57) ABSTRACT

A parking system and method is disclosed. The system facilitates coordination and communication between users to aid in parking transactions. For instance, one user may wish to occupy the parking spot of another user. The system and method allows users to display parking spots in the system such that they can be viewed by other users, and to request or to book parking spots posted by other users. The system may include an exchange medium in the form of points that can be swapped for parking spots or any other currency or payment method to incentivize the transfer of parking spots between users. The database may include any kind of parking spot from any source, including parking spots posted by other users on streets with free parking.

### CROSS-REFERENCE TO RELATED PATENT APPLICATIONS

The application claims the benefit of priority from U.S. Provisional Application No. 62/493,643 filed Jul. 11, 2016, the entire contents of which is incorporated herein by reference.

### FIELD OF THE INVENTION

The current invention involves a parking system and method to facilitate parking transactions between users.

### BACKGROUND OF THE INVENTION

In many cities today, it is difficult to find parking, and especially affordable parking. One might arrive at a location and drive in circles for a substantial amount of time searching for a parking space. A recent article in the The Economist reported an estimate that “cruising for spaces in Westwood village, in Los Angeles, amounts to 950,000 excess vehicle miles travelled per year. Westwood is tiny, with only 470 metered spaces.” (The Economist, Sacred Spaces, Apr. 8, 2017). Driving in search of parking spaces is not only a waste of time, but congests the roads unnecessarily with extra traffic and can contribute to air pollution.

Some parking applications have arisen that require paying for parking spots in advance for garages and lots. Yet they do not provide a means of securing free street parking. There is currently no way for a person to easily secure street parking, which is why so many vehicle miles are wasted each year in searching for such parking spaces.

The present invention solves this problem. It provides a method and system to facilitate coordination between users of the parking system, such that users are able to search for and secure any kind of parking from other users, including free street parking. It is a system that facilitates communication between users and a transaction of exchange.

### SUMMARY OF THE INVENTION

The invention facilitates coordination between users such that a departing parker can advertise a parking spot, and an arriving parker can find the parking spot through a search in the system, and the two users can enter into a transaction to exchange the spot during a particular time frame. Such a system should include GPS and mapping technology so that real-time location information could facilitate the exchange. The system could be used in various embodiments: through smartphones (a preferred embodiment), tablets, computers, and also through vehicles themselves. The system could also in a preferred embodiment have a system of currency exchange that could include points used within the system to incentivize exchange for parking spots.

### BRIEF DESCRIPTION OF DRAWINGS

FIG. 1 is a system diagram of an online system for coordinating the exchange of parking spots.

FIG. 2 is a Login interface screen of an embodiment of the invention.

FIG. 3 is a Home page screen of an embodiment of the invention.

FIG. 4 is a Sign Up interface page screen of an embodiment of the invention.

FIG. 5 is a second Sign Up interface page screen of an embodiment of the invention.

FIG. 6 is a third Sign Up interface page screen of an embodiment of the invention.

FIG. 7 is a Congratulations interface page screen of an embodiment of the invention.

FIG. 8 is a Find Parking interface page screen of an embodiment of the invention.

FIG. 9 is a Map of Available Parking Spots interface page screen of an embodiment of the invention.

FIG. 10 is a Pop-up Screen interface page screen with a parking spot selected screen of an embodiment of the invention.

FIG. 11 is a Parking Spot Details interface page screen of an embodiment of the invention.

FIG. 12 is a Parker Information interface page screen for the departing parker of an embodiment of the invention.

FIG. 13 is a Request Spot interface page screen of an embodiment of the invention.

FIG. 14 is a Confirmation interface page screen of an embodiment of the invention.

FIG. 15 is a Post a Parking Spot interface page screen of an embodiment of the invention.

FIG. 16 is a Parking Spot Confirmation interface page screen of an embodiment of the invention.

FIG. 17 is a Parking Spot Details interface page screen of an embodiment of the invention.

FIG. 18 is a Congratulations: Spot Posted interface page screen of an embodiment of the invention.

FIG. 19 is a Receiving Request interface page screen of an embodiment of the invention.

FIG. 20 is an Accepting Transaction interface page screen of an embodiment of the invention.

FIG. 21 is an Active Transactions interface page screen of an embodiment of the invention.

FIG. 22 is a Cancel Transaction interface page screen of an embodiment of the invention.

FIG. 23 is a Cancel Confirmation interface page screen of an embodiment of the invention.

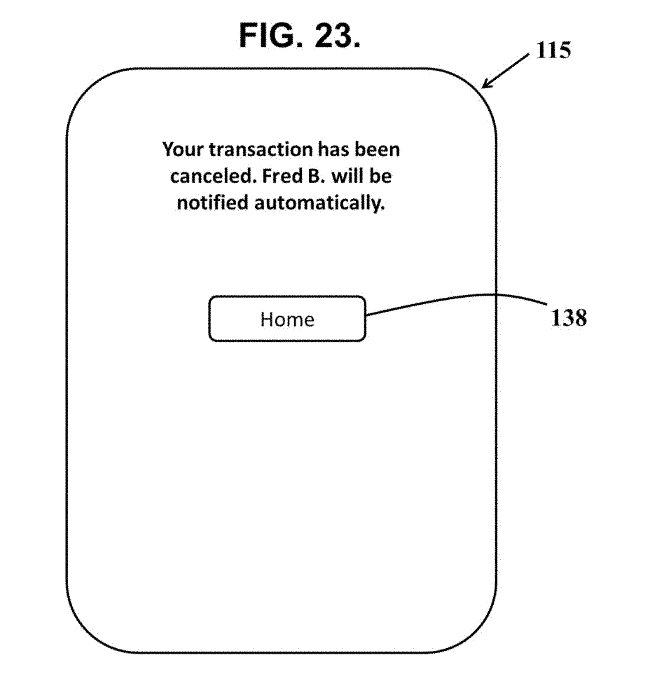

FIG. 24 is a Contact User interface page screen of an embodiment of the invention.

FIG. 25 is a My Profile interface page screen of an embodiment of the invention.

FIG. 26 is a Real-Time Route interface page screen of an embodiment of the invention.

FIG. 27 is a Parking Swap Confirmation interface page screen of an embodiment of the invention.

FIG. 28 is a Rate User interface page screen of an embodiment of the invention.

FIG. 29 is a Congratulations interface page screen of an embodiment of the invention.

FIG. 30 is a Settings interface page screen of an embodiment of the invention.

FIG. 31 is a Search Settings interface page screen of an embodiment of the invention.

FIG. 32 is a Posting Settings interface page screen of an embodiment of the invention.

FIG. 33 is a Settings Saved interface page screen of an embodiment of the invention.

### DETAILED DESCRIPTION OF INVENTION

The present invention relates to a system facilitating coordination and communication between users of a parking system. The system may be adapted for use with any type of vehicle and with any type of user. The user could be a driver. The user may also be a passenger or an owner of a vehicle.

The present invention facilitates coordination between users by communicating information about a first user to one or more other users. The system also communicates information about one or more other users to the first user.

The system would allow a user to search for a parking spot near a location of choice. The parking system could return available parking spots to the user, some of which may be advertised by other users in the system. The available parking spots might be displayed on a map. The user may then book a spot either from another user or from other parking sources within the system.

Individual departing users may through the system post parking spots that will be vacated when they depart from a spot, such as a street parking spot. Thus, the system can include street parking spots, including free parking. The system can allow an arriving user to select a parking spot from a departing user, and for the two to agree to a transaction of exchange. Note that while street parking is an especially useful type of parking for this system, the type of parking used in the system need not be limited by type: it could include streets, public and private lots, garages, driveways, etc., which could be in different embodiments.

In one preferred embodiment, the transaction of exchange between users could be incentivized by a swap of points between the users, points that could be used in the parking system to acquire other parking spots. Users may be able to adjust their settings, depending on whether they want for instance to restrict their searches to free parking spots, and whether they want to restrict their searches to only other users with which they have mutual friends. There may be other settings, and those skilled in the art will note that other embodiments may be envisioned with different search filters and other settings.

As will be described in more detail below, the information exchanged between users may include, but need not be limited to: profile data, vehicle information, location, mutual friends, parking spot information, rating information, route information, and current direction of travel.

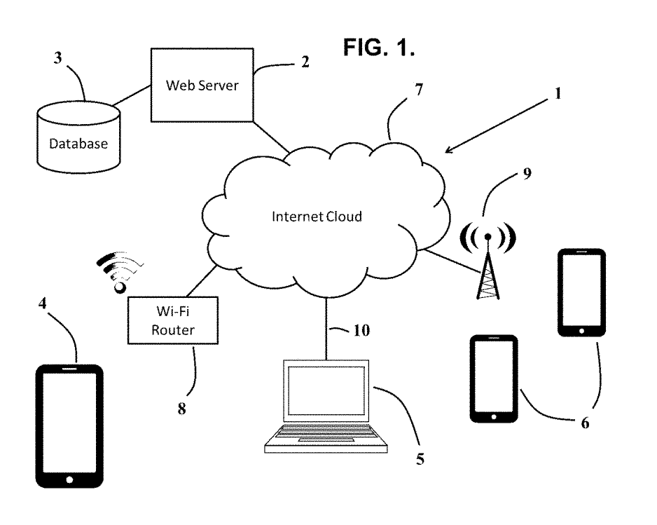

A system 1 for facilitating the parking system is shown in FIG. 1. The system 1 includes a web server 2, a data store 3 and a plurality of user interface devices, such as for example, a tablet computer 4, a laptop or desktop computer 5, or a smartphone 6. The user interface devices may connect to the internet 7 wirelessly via a Wi-Fi router 8, an LTE data or cellular connection 9 or some other wireless communication method. Alternatively, a desktop computer 5 may connect to the internet 7 directly via a hardwired network connection 10. Another embodiment could include a computer program and screen that is part of a vehicle itself. Many of the features provided by the present invention are most useful when a user is out in a car. Accordingly, a preferred user interface device will generally be a smartphone 6, or some other mobile computing device. The remainder of the present description will refer to the user input device as a smartphone 6; however, those skilled in the art will recognize that the user interface device may be any suitable computing device capable of sending and receiving data over the internet 7 as well as receiving input data from the user and displaying output data to the user, even including a vehicle itself. Each user's smartphone 6 includes a software application adapted to present a plurality of interactive user interface pages to the user. As will be described more fully below, the user interface pages are adapted to elicit input data from users. The software application executed by the user's smartphone is further adapted to communicate the data about the user to the web server 2 over the internet 7, where it is stored in the data store 3.

The data about the user collected by the smartphone and transmitted to the web server 2 and stored in the data store 3, as well as data about other users pulled from the data store 3 and transmitted to and displayed by the user's smartphone 6 is most easily understood by reviewing the user interface presented to the user by the user's smartphone 6.

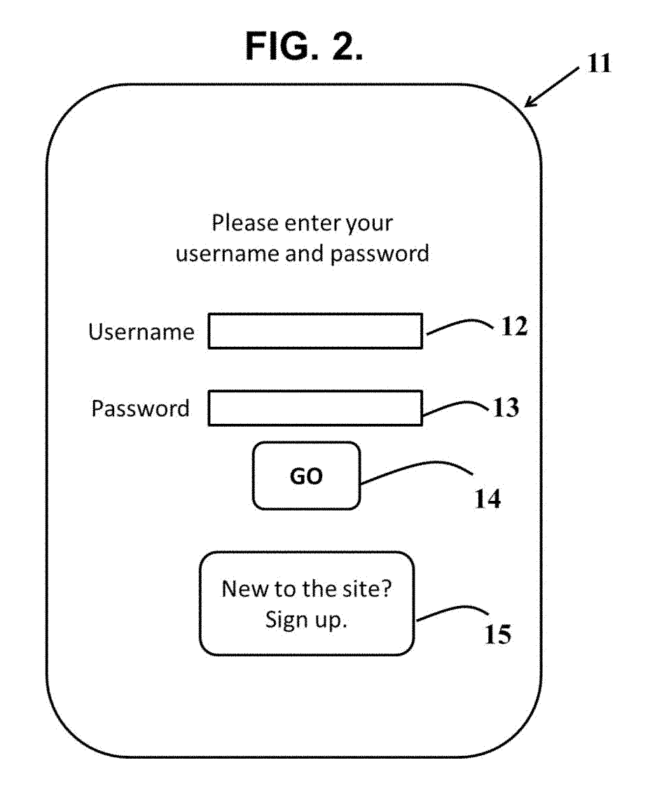

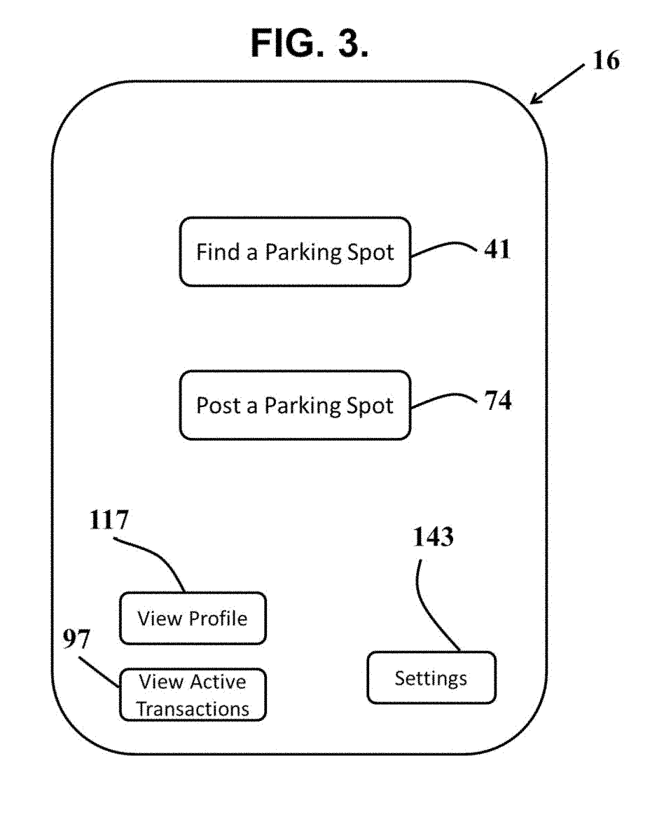

Turning to the user interface, FIG. 2 is a Login screen 11 that the application executed on the user's smartphone display screen causes to be displayed on the user's smartphone display screen when the user opens the parking application on the device. The Login screen includes a Username text field 12, a Password text field 13, a Go button 14, and a Sign Up button 15. The user interface allows the user to enter text in the Username and Password text fields 12 and 13, as is well known in the art. Once the user has entered his or her Username and Password into the Username and Password text fields 12, 13, the user may select the Go button 14 to log on to the application and access a previously established user account. The system verifies the username and password entered by the user. If the username and password correspond to a previously established account, the user's smartphones 6 displays a Home page 16 as shown in FIG. 3. If the user is new to the application and has not yet established a user account, the user may select the Sign Up button 15.

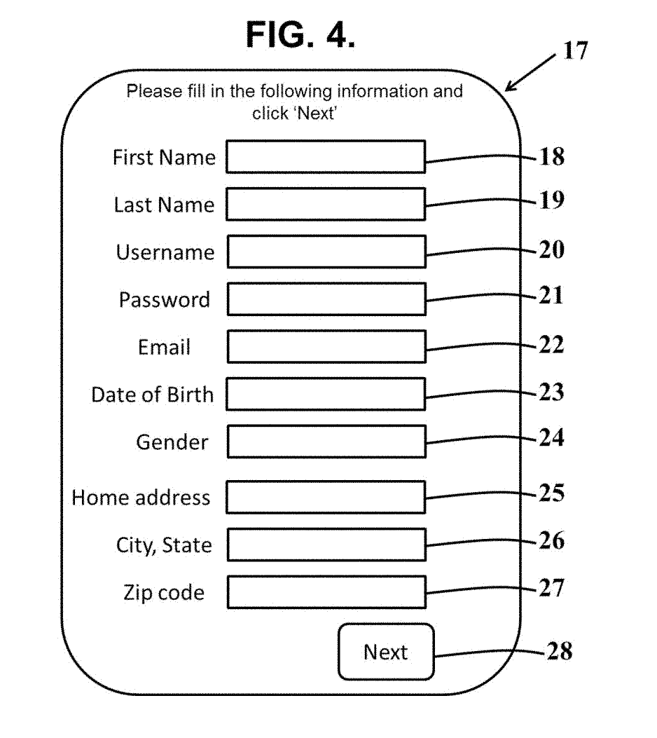

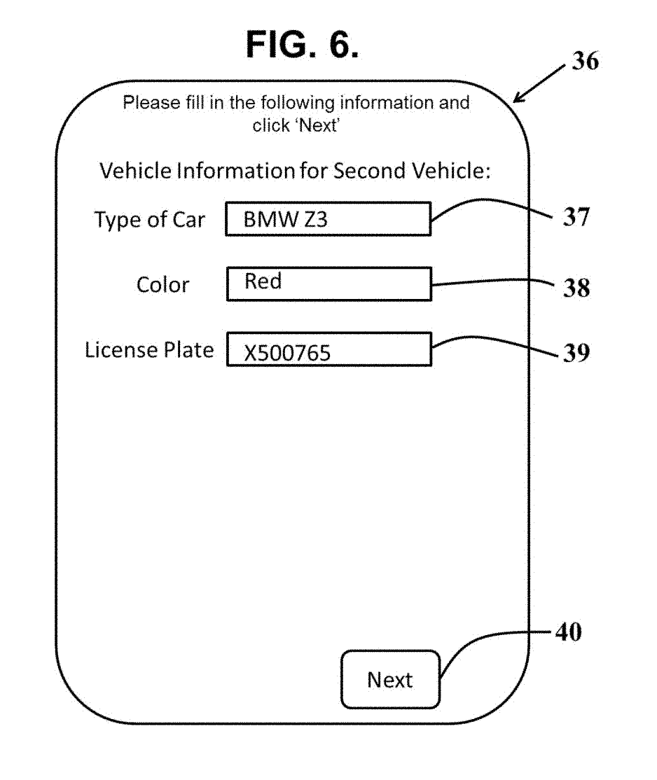

FIGS. 4-6 are user interface pages associated with the creation of a new user account. The user's smartphone displays the first Sign Up page 17 shown in FIG. 4 when the user selects the Sign Up button 15 from the Login screen 11 of FIG. 2. The Sign Up page 17 includes a number of text fields for receiving information about the user. The text fields on the first Sign Up page 17 may include but are not limited to: First Name 18, Last Name 19, Username 20, Password 21, Email 22, Date of Birth 23, Gender 24, Home Address 25, City, State 26, Zip Code 27. A prompt at the top of the page 17 instructs the user to enter the appropriate information into the various text fields 18, 19, 20, 21, 22, 23, 24, 25, 26, 27, and to select the Next button 28.

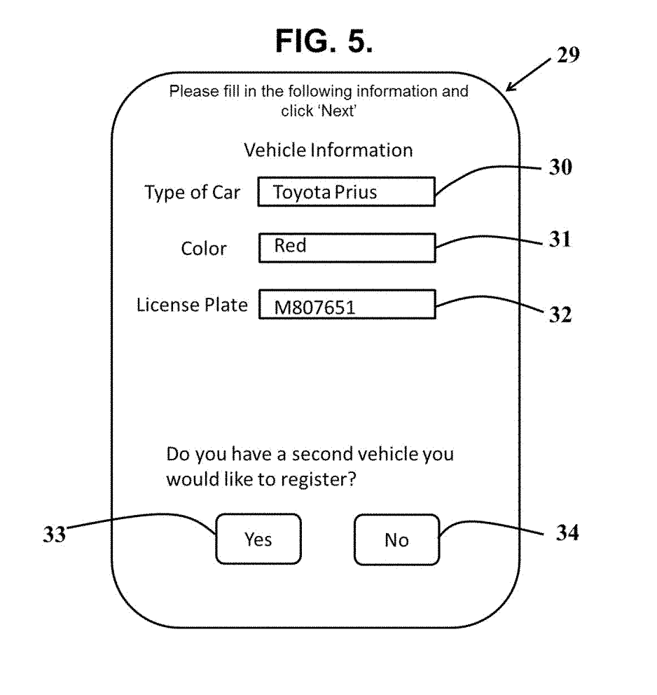

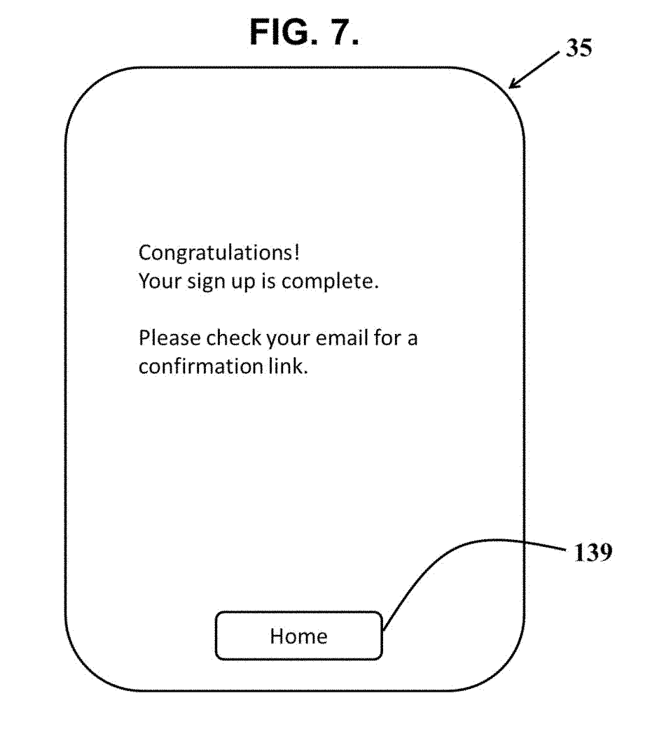

Upon entering the appropriate information in the text fields 18, 19, 20, 21, 22, 23, 24, 25, 26, 27, and selecting the Next button 28, the user's smartphone 6 displays the second Sign Up page 29 as shown in FIG. 5. The text fields in the Second Sign Up page include but are not limited to: Vehicle information including Type of Car 30, Color of Car 31, and License Plate # 32. The prompt at the top of the Second Sign Up page 29 instructs the user to enter the appropriate information into the text fields, and then to answer the question of the second vehicle Yes 33 or No 34. If No 34 is selected, then the user's smartphones 6 displays the Congratulations page 35 shown in FIG. 7. If Yes 33 is selected from the Second Sign Up Screen 29, then the user's smartphone 6 displays a Third Sign Up page 36. The text fields in the Third Sign Up page 36 include: Type of Car 37, Color of Car 38, and License Plate # 39. The prompt at the top of the Third Sign Up page 36 instructs the user to enter the appropriate information in the text fields 37, 38, 39, and to select the Next button 40. Upon entering the appropriate information in the text fields 37, 38, 39, and selecting the Next button 40, the user's smartphone 6 displays the Congratulations page 35.

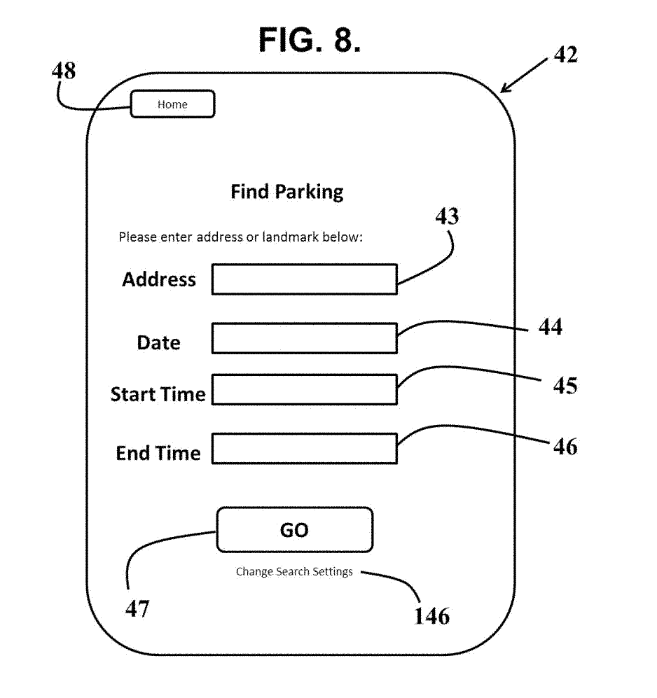

Returning now to the Home Screen 16 as shown in FIG. 3, when a user selects the Find a Parking Spot button 41, the user's smartphone 6 displays the Find Parking page 42 as shown in FIG. 8. The text fields in the Find Parking page 42 include but are not limited to: Address 43, Date 44, Start Time 45, and End Time 46. A prompt at the top of the Find Parking page 42 will instruct the user to fill in the appropriate text in the fields 43, 44, 45, 46, and to select the Go button 47.

A Home button 48 is available at the top of the Find Parking screen 42. If the Home button 48 is selected, it will cause the user's smartphone to display the Home screen 16 as shown in FIG. 3.

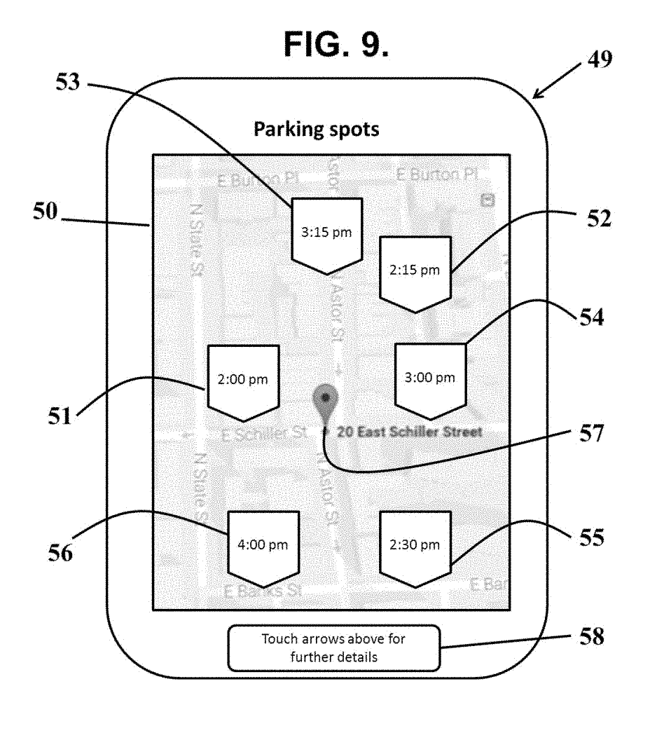

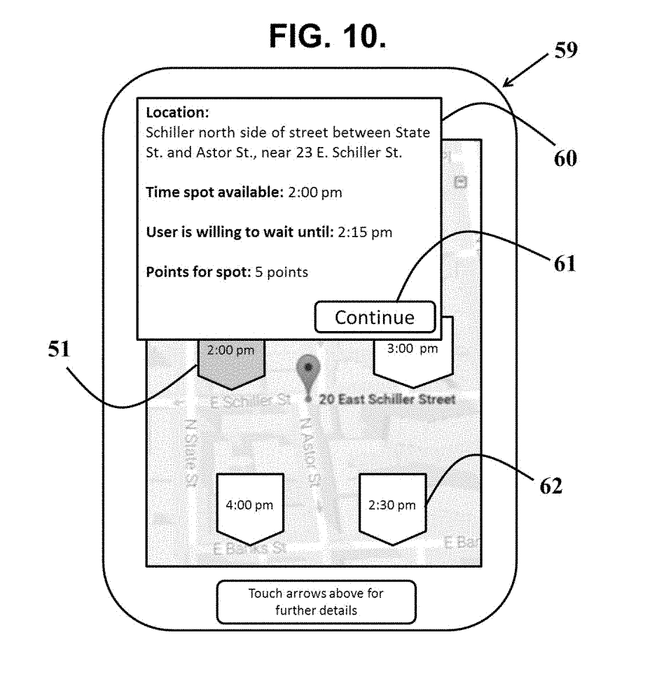

Returning to the Find Parking screen 42 as shown in FIG. 8, if the user fills in the appropriate texts in the fields 43, 44, 45, 46, and then selects the Go button 47, then the user's smartphone will display the Map of Available Parking Spots screen 49 as shown in FIG. 9. The Map of Available Parking Spots will contain data from the Data Store 3. The Map of Available Parking Spots screen 49 may include a Map 50, arrows displaying available Parking Spots 51, 52, 53, 54, 55, 56, and an arrow pointing to the address searched for 57. The prompt 58 instructs users to touch a Parking Spot arrow to view its details. Upon selecting Parking Spot 51, the user's smartphone displays a Map Pop-Up screen 59 as shown in FIG. 10. This page 59 may include a pop-up 60 that displays details of Parking Spot 51. Note that if the user had selected Spot 52 instead of Spot 51 from the Map of Available Parking Spot page 49 of FIG. 9, then a similar pop-up would be displayed in the Pop-up Screen 59, containing information on Spot 52 instead of Spot 51, and similarly for any other spot selected in the Map screen 49. Note that as instructed by the prompt on the Map Pop-Up Screen 59, the user may also click on an alternative spot such as spot 62, and on this screen 59 a pop-up appropriate to spot 62 would display in place of the old pop-up 60.

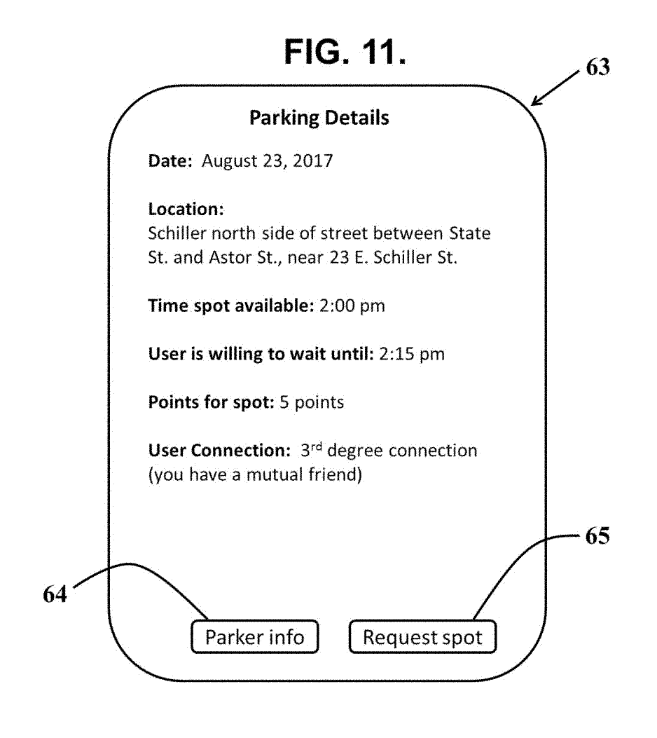

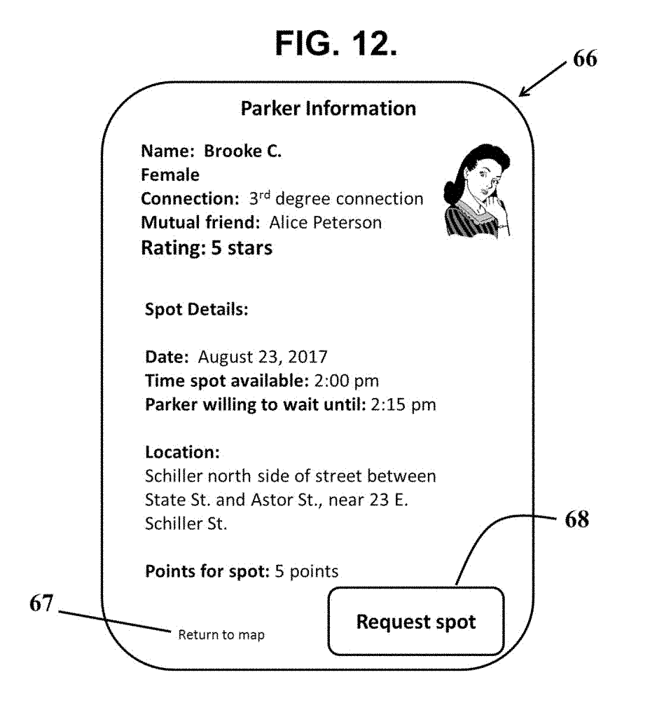

The pop-up 60 displayed on the Map Pop-Up screen 59 may include but is not limited to such information as: address and location specifics, time of spot availability, time the user is willing to wait, and number of points needed for the spot. When the user selects the Continue button 61, then the user's smartphone displays the Spot Details page 63 as shown in FIG. 11. The Spot Details page may include but is not limited to the date of the parking spot, the location of the parking spot, the time the spot is available, the time the user is willing to wait, the points for the spot, and whether the user has a connection such as mutual friends. If the user selects the Parker Info button 64, the user's smartphone displays the Parker Information page 66 as shown in FIG. 12. This page may include details about the parker such as name (in this case Brooke C.), mutual friends, gender, rating information, a picture, as well as the parking spot details that may include, date, time, time the parker is willing to wait, location, and points for the spot. It the user selects the Return to Map button 67, the user's smartphone will display the Map of Available Parking Spots Screen 49, as shown in FIG. 9.

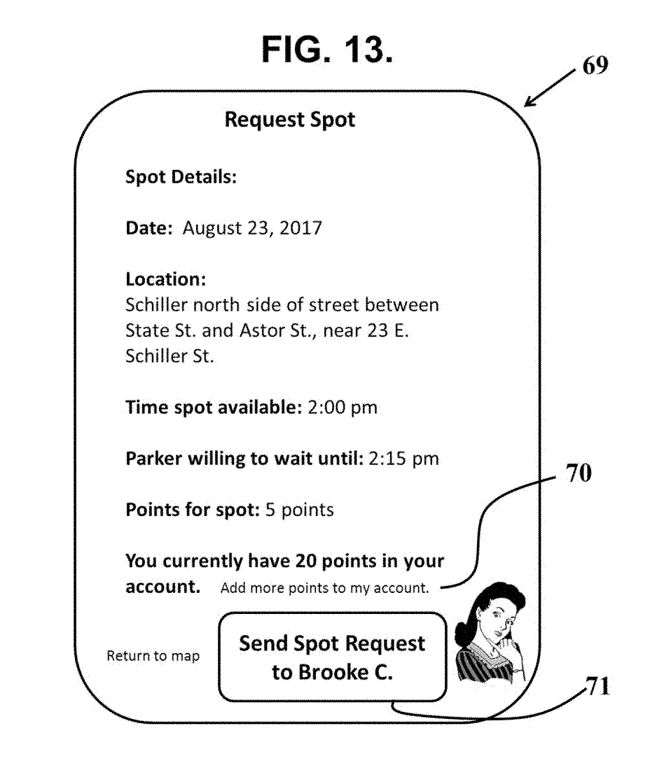

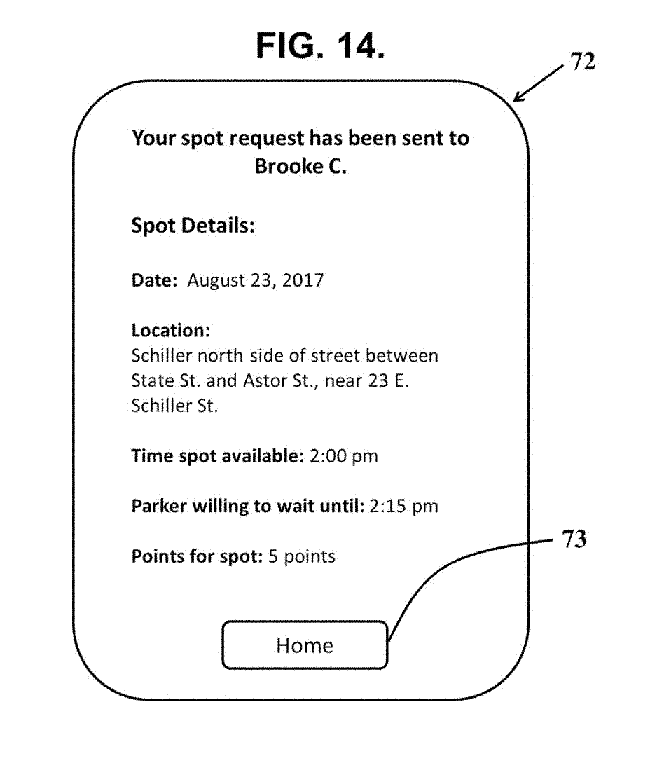

Alternatively, if the user (who in this case we shall name “Fred. B.”) instead clicks the Request Spot button 68 on the Parker Information screen 66 of FIG. 12, or clicks the Request Spot button 65 on the Spot Details screen 63 of FIG. 11, then the user's smartphone will display the Request Spot screen 69 as shown in FIG. 13. This screen 69 may include the parking spot details such as date, location, time available, time parker willing to wait, points for spot in one embodiment, price of spot in another embodiment, and information. The screen 69 may also include the number of points available on the user's account in an embodiment that includes points as a medium of transaction (other embodiments could include other forms of currency such as actual currency, Bitcoin, electronic currency, credit cards, PayPal, or other forms of payment not listed here). In one preferred embodiment the screen 69 may include a button 70 for the user to add more points to his or her account, and when this button is clicked, the user's smartphone would display a page to purchase more points, which may be in the form of any embodiments commonly known in the art of electronic payments. When the user (“Fred”) has sufficient points to complete the transaction to acquire the spot from the other user, “Brooke C.” in our example, and the user “Fred” clicks the button Send Spot Request 71 on the Request Spot screen 69 of FIG. 13, then the spot request is sent to the other user, in this example Brooke C. Once the Send Spot Request button 71 is selected, the user Fred's s smartphone displays a Confirmation page 72 shown in FIG. 14, which informs the user Fred that his spot request was sent, in this case to “Brooke C.”. When the user Fred clicks the Home button 73, the user Fred's smartphone 6 displays the Home screen 16 as shown in FIG. 3.

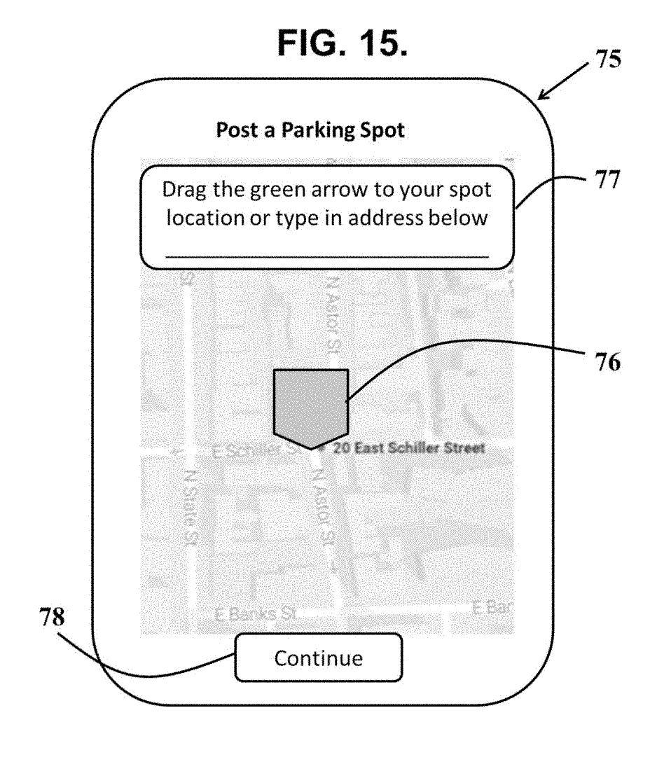

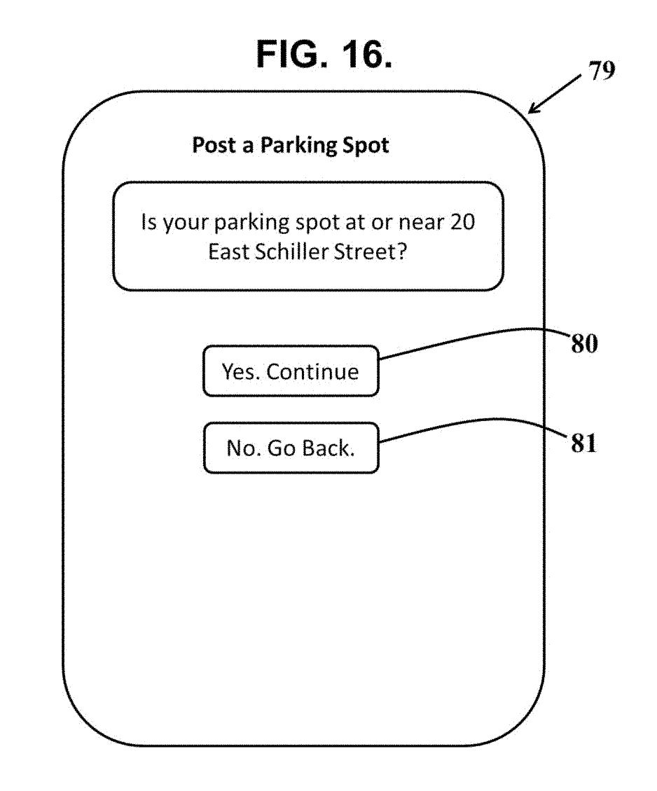

Next we shall turn to the user who is posting a parking spot (in our example, this is “Brooke C.”). One of the buttons on the Home screen 16 of FIG. 3 is the Post a Parking Spot button 74. When the user selects this button 74, the user's smartphone 6 displays the Post a Parking Spot page 75 as shown in FIG. 15. The prompt on the screen directs the user to drag the arrow 76 to the location of his or her parking spot on the map, or to enter the address of the parking spot in the text field 77. Once the user has followed the instructions of the prompt of this screen 75 and either dragged the arrow or entered an address, and pressed the Continue button 78, it causes the user's smartphone 6 to display a Spot Confirmation screen 79, as shown in FIG. 16. This screen 79 has a prompt to confirm the location of the parking spot, and two buttons ‘Yes. Continue’ 80, and ‘No. Go Back’ 81. When the user clicks the No button 81, the user's smartphone 6 displays the first Post a Parking Spot page 75 as shown in FIG. 15, where the user is able to again drag the arrow on the map or enter an address.

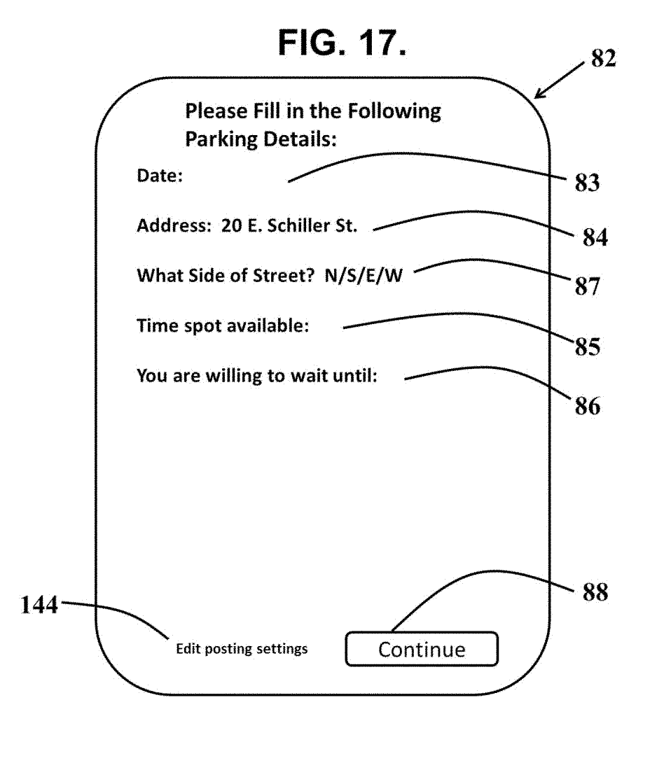

Alternatively, if the user on the Spot Confirmation screen 79 of FIG. 16 selects the Yes button 80, then the user's smartphone displays the Spot Details page 82 as shown on FIG. 17.

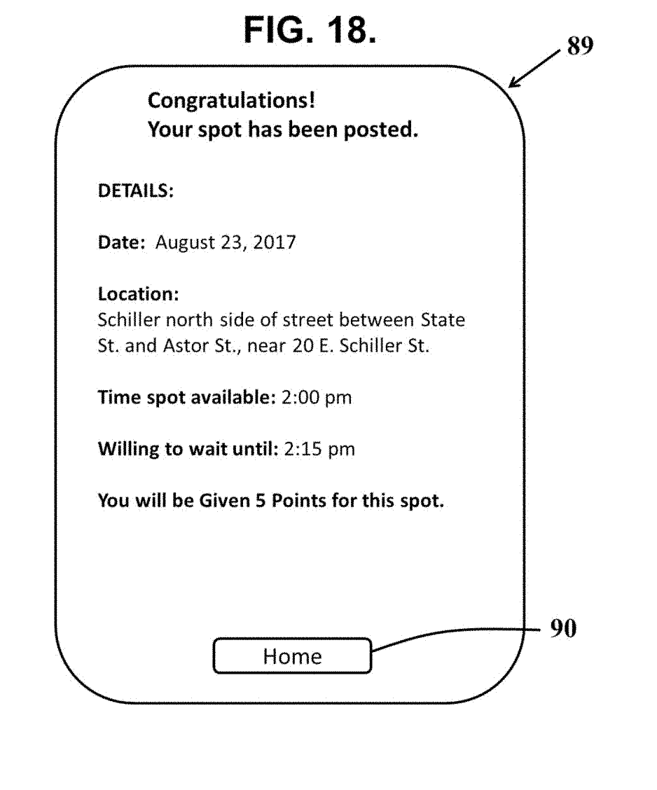

The Spot Details page 82 includes a number of text fields for receiving information about the user's parking spot. The text fields on the Spot Details page 82 may include but are not limited to: Date of Parking Spot Availability 83, Address of Parking Spot 84, Time Parking Spot Available 85, Time User is Willing to Wait for the Arriving Parker 86. There will also be a directions field for what side of the street the parking spot is on 87—North, South, East, or West, where the user can select the appropriate direction. A prompt at the top of the page 82 instructs the user to enter the appropriate information into the various fields 83, 84, 85, 86, 87 and to select the Continue button 88, which causes the user's smartphone to display the Congratulations page 89 as shown in FIG. 18. The Congratulations page 89 can confirm that the spot has been posted, and the details of the spot including but not limited to the date, location, time, time to wait, and points for the spot. When the user clicks the Home button 90, the user's smartphone 6 displays the Home screen 16 of FIG. 3. Let us again assume, as before, that the user who has just posted a spot is “Brooke C.”

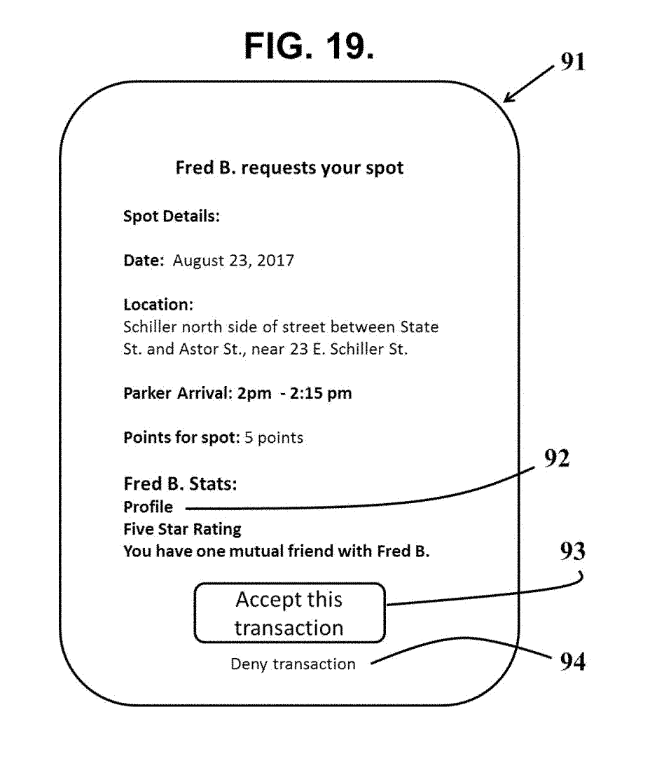

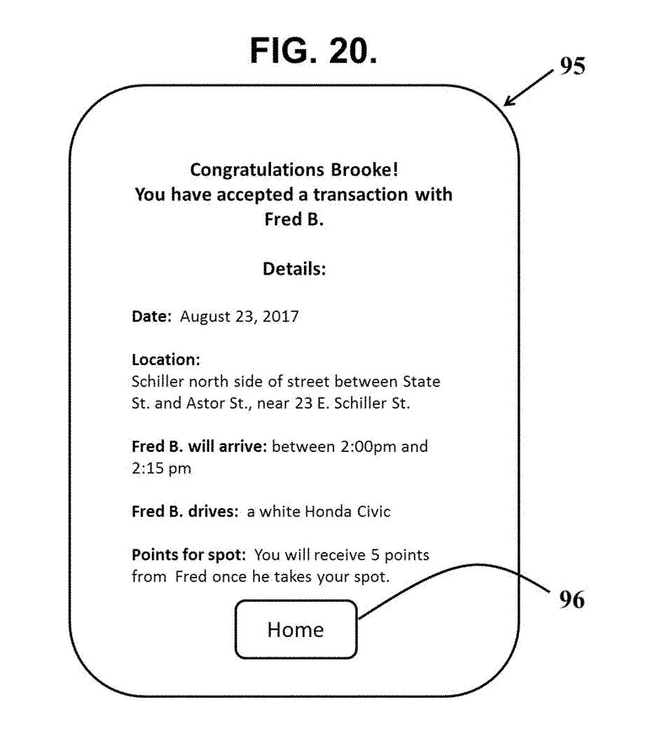

For purposes of example, the other hypothetical user “Fred B.” has requested a spot posted by “Brooke C.” by clicking as described earlier on the button Send Spot Request 71 on the Request Spot screen 69 of FIG. 13. At this point turning again to Brooke C's screen, the departing parker user, Brooke C. will receive a notification and her smartphone 6 may display the Receiving Request screen 91 of FIG. 19. This screen 91 can detail which user has requested her spot (in this case “Fred B.”), the date, location, time Fred B. expects to arrive, points (or price) for the spot, Fred B's rating, mutual friends, and a link to Fred B's profile. The user Brooke may click on Fred's Profile link 92 to view his profile and mutual friends, which would lead to a profile page similar to the Parker Information Screen 66, as shown in FIG. 12, except the profile information would be of Fred instead of Brooke. Returning to the Receiving Request screen 91 of FIG. 19, the user Brooke when she decides if she would like to transact with Fred, may click on one of two buttons, the Accept Transaction button 93, or the Deny Transaction button 94. If user Brooke clicks the Deny Transaction button 94, then her smartphone will display a simple screen stating the transaction has been denied. If user Brooke instead clicks the Accept Transaction button 93 on the Receiving Request Screen 91, her smartphone will display an Accepting Transactions page 95 as shown in FIG. 20. This page can congratulate the user Brooke and summarize the details of the spot including date, location, time of arrival, vehicle type of user Fred's car, and points for spot. Here, user Brooke may click on the Home button 96 to return to the Home screen 16 as shown in FIG. 3.

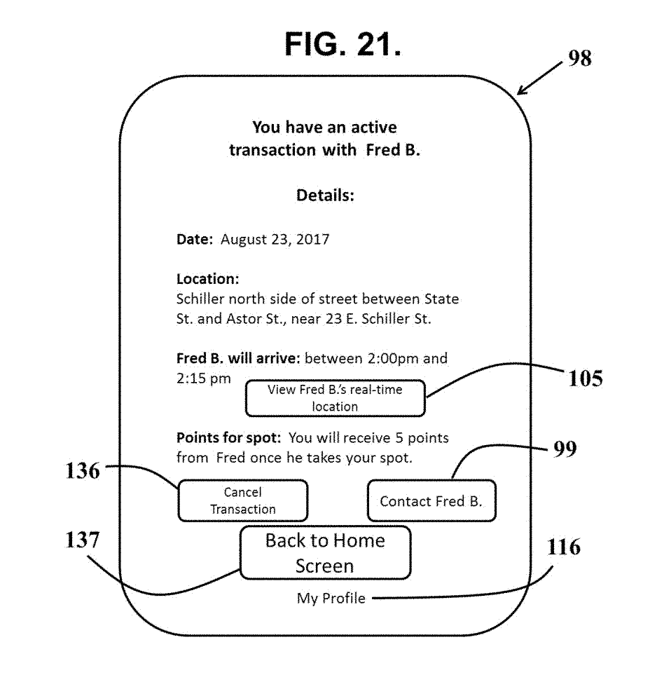

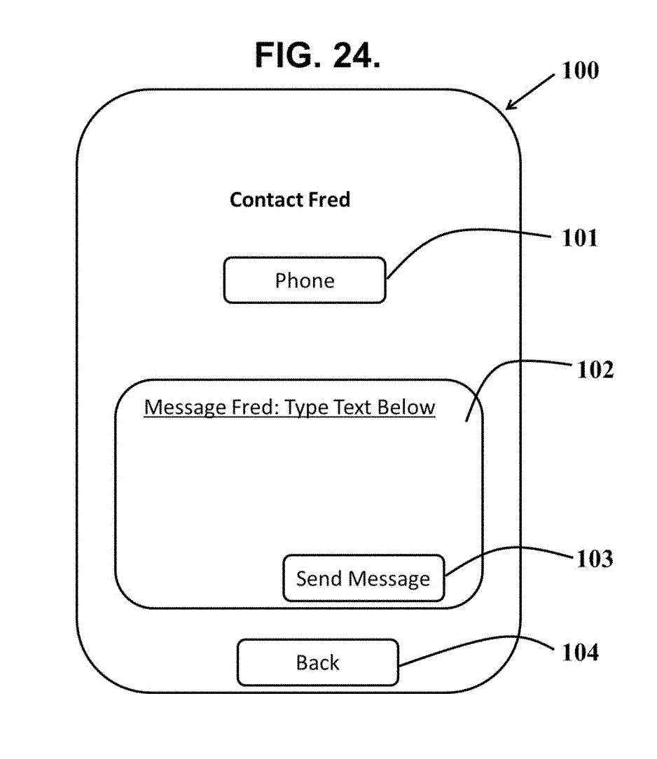

Note that now our user Brooke has an active transaction. From the Home Screen 16 of FIG. 3, user Brooke may click on the View Active Transactions button 97, which would cause her smartphone to display the Active Transactions page 98 as shown in FIG. 21. This page can contain details of the transaction including date, time, arrival time, and points for the spot. Near the bottom of the page is a Contact User button (in this case “Contact Fred B.”) 99. If the hypothetical user Brooke clicks the “Contact Fred” button 99, the user Brooke's smartphone displays the Contact User page 100 as shown in FIG. 24. Here the Phone button 101 will direct the smartphone 6 to the user Fred's phone number. The user Brooke could also press the Back button 104 to return to the previous screen. Alternatively, the user Brooke could enter text in the field beneath the Message prompt 102 and click the Send Message button 103, which would send a message to the web server 2, which in turn would retransmit the message to the user Fred, and also display a confirmation to user Brooke's smartphone that the message was sent.

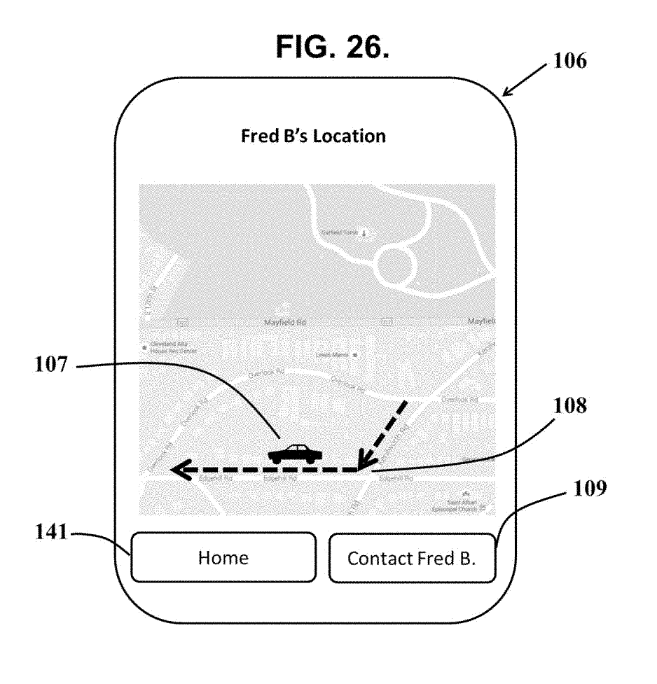

Returning to the Active Transactions page 98 of FIG. 21, user Brooke C. can click the View User's Real-Time Location button 105 (in this case Fred B's location), which will cause user Brooke C's smartphone to display the Real-Time Route page 106 as shown in FIG. 26. Here a map can show Fred B's car as an icon 107 traversing a path along the map, and arrows 108 will indicate the direction of travel. Clicking the Contact button 109 of FIG. 26 will direct the user Brooke's smartphone to display the Contact screen 100 as shown in FIG. 24, from which the user Brooke may phone or email the other user Fred.

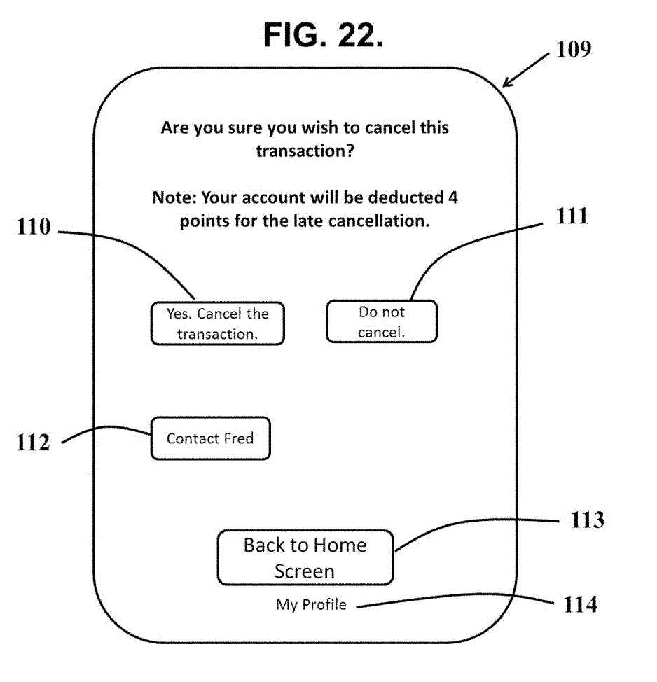

Returning again to the Active Transactions page 98 of FIG. 21, when the Cancel Transaction button 136 is clicked, then the user Brooke's smartphone will display the Cancel Transaction page 109 as shown in FIG. 22. The top of this screen 109 will prompt the user to select one of the buttons below: Yes. Cancel the Transaction 110, Do not Cancel 111, Contact Fred 112, Home Screen 113, or My Profile 114. If the user selects Contract Fred 112 on the Cancel Transaction screen 109, the user's smartphone will display the Contact screen 100 as shown in FIG. 24. If the user Brooke on screen 109 clicks the ‘Yes. Cancel the transaction’ button 110, her smartphone will display a Cancel Confirmation page 115, which can explain that the transaction has been canceled and that the other user Fred. B. will be notified automatically. Alternatively, if the user Brooke on screen 109 of FIG. 22 clicks the Do Not Cancel button 111, the transaction with Fred. B. will not be canceled, and user Brooke C.'s smartphone will display the Active Transactions page 98 of FIG. 21.

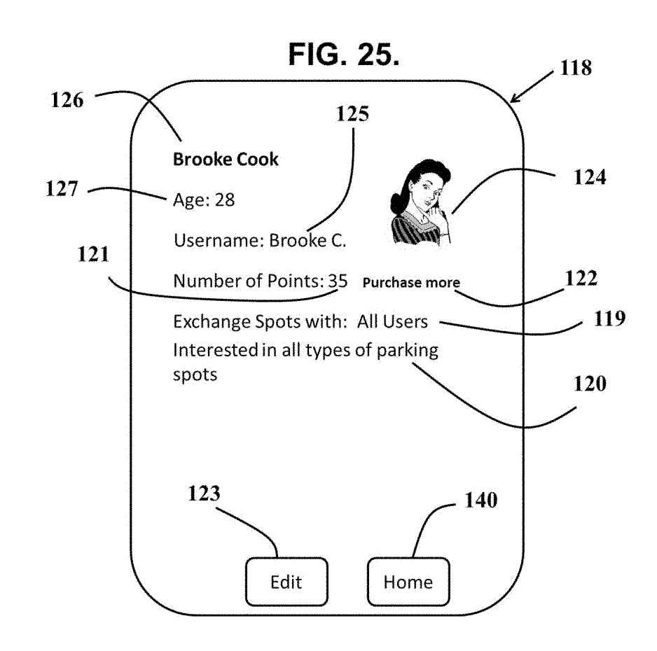

On nearly all of the screens in this application, one should note that a Home Screen button would be present, as for example, in Home button 113 of the Cancel Transaction screen 109 of FIG. 22, or the Home button 90 of the Spot Posted screen 89 of FIG. 18, or the Home button 137 of the Active Transactions screen 98 of FIG. 21, or Home buttons 138, 149, 48, 90, 140, 141, 142, 149, etc. Even if the Home screen button is not specifically listed on every screen Figure does not mean there could not be one. Similarly, the My Profile button 114 of the Cancel Transaction screen 109 of FIG. 22 or the My Profile button 116 of the Active Transactions screen 98 of FIG. 21, or the My Profile button 117 on the Home screen 16 of FIG. 3, could be present on any screen to aid the user in editing his or her profile. When the user clicks the My Profile button 114, 116, or 117, the user's smartphone displays the My Profile page 118 as shown in FIG. 25. Here the page may display such information as name 126, age 127, username 125, interest in types of parking spots 120, users interested in exchanging spots with 119, and points 121. These settings could be adjusted by the user clicking on the Edit button 123, and then clicking on any of the profile fields (such as Picture 124, username 125, Exchange spots 119, Interested in Parking Spots setting 120, etc.) and typing text or selecting a radio button where applicable. For instance, if a user wants to only exchange spots with other users with which the user has mutual friends, the Exchange Spots setting 119 could be changed from ‘All Users’ to a more restrictive setting of users that are friends or users that have mutual friends with the user. Similarly, the Interested in Parking Spots setting 120 could be adjusted depending on if the user is interested in paid garage parking, lot parking, street parking, and/or free parking. The Number of Points Field in one embodiment 121 would display the number of points the user currently has in his or her account. In other embodiments this page might display other forms of currency. The Purchase More link 122 may be clicked by the user, causing the user's smartphone to display a payment page, which may include electronic payment services such as Paypal or a simple credit card transaction or subscription, in different embodiments, as those skilled in the art will be familiar with. The Profile page 118 may also display a Picture of the user 124, which the user may change as desired by clicking on the Picture 124.

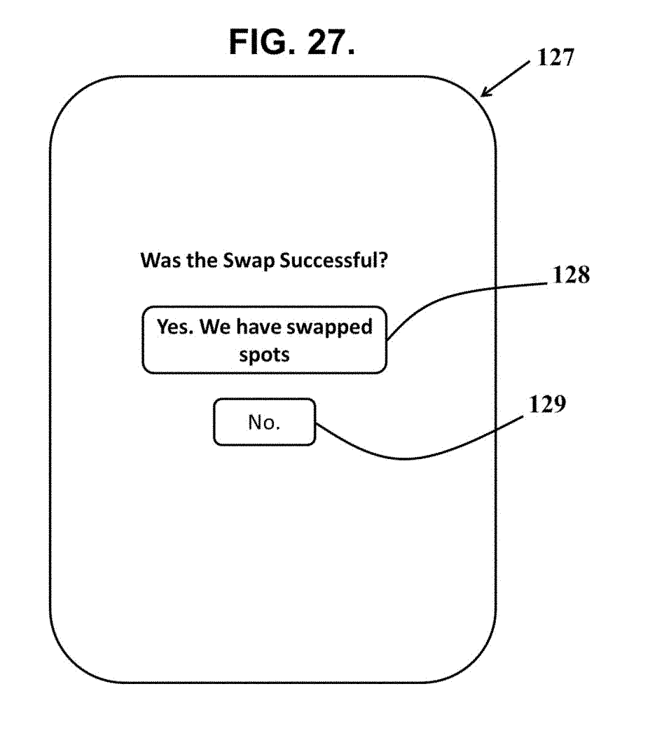

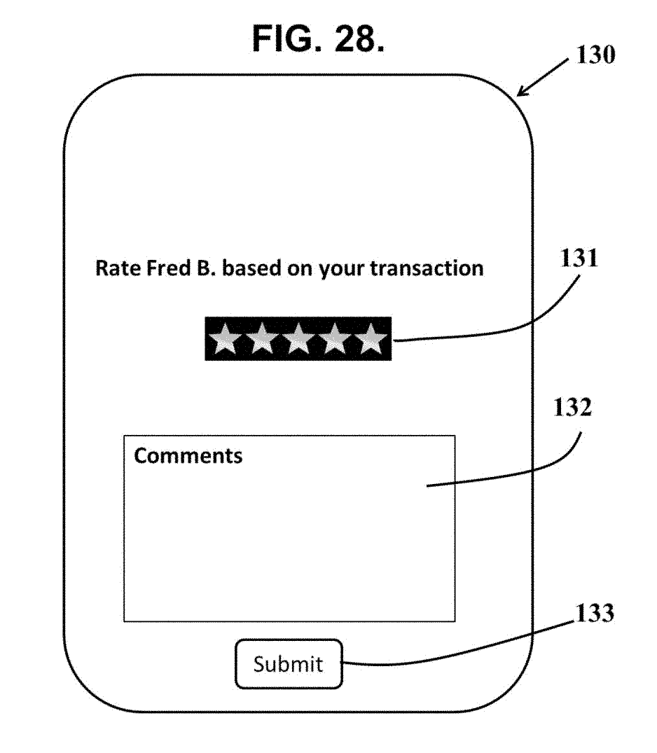

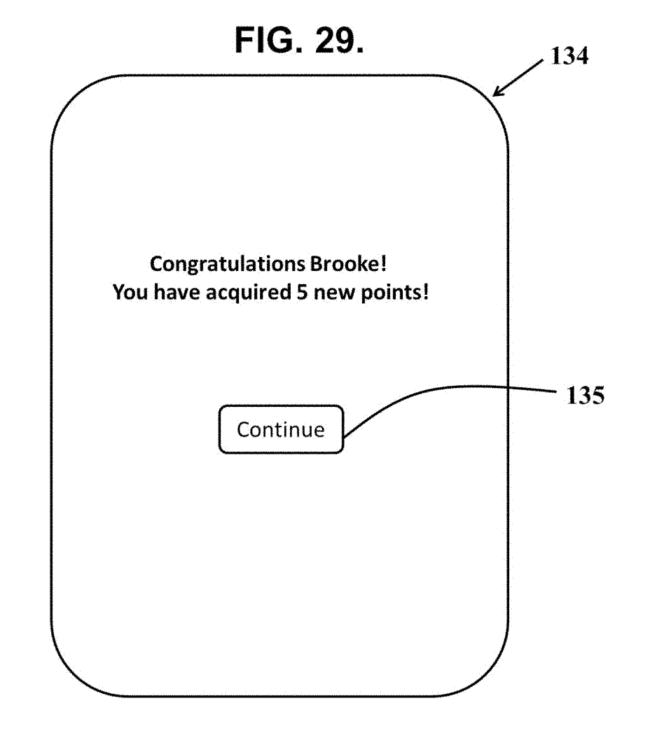

After a scheduled parking swap transaction time has passed, both parties to the transaction may be prompted for a confirmation. Each user's smartphone will display the Parking Swap Confirmation page 127 shown in FIG. 27. This page will have a prompt asking the user if the swap was successful. If the user clicks the Yes button 128 or the No button 129, the user will be directed to the Rate User page 130 shown in FIG. 28. Here the user may be prompted to click on the stars to select a star rating 131 for the other user (in this case “Fred. B”), and to write in the comments 132 how the transaction went. Once all fields are completed on the Rate User screen 130 of FIG. 28, and the Submit button 133 is pressed, and if the Yes button 128 had also been clicked on the previous Parking Swap Confirmation page 127 of FIG. 27, then the user's smartphone will display the Congratulations page 134. The Congratulations page 134 will congratulate the user on the successful transaction and list the points involved in the transaction. Alternatively, if all the Rate User page 130 fields of FIG. 28 were completed and the Submit button 133 clicked by the user, but the user had clicked the No button 129 on the previous Parking Swap Confirmation page 127 of FIG. 27, then the user's smartphone would display a similar page to 134 of FIG. 29, except it would not display Congratulations but would merely in text relate the transaction in terms of points exchanged or reduced. Once the Continue button 135 is clicked on screen 134, it would cause the user's smartphone to display the Home screen 16 of FIG. 3.

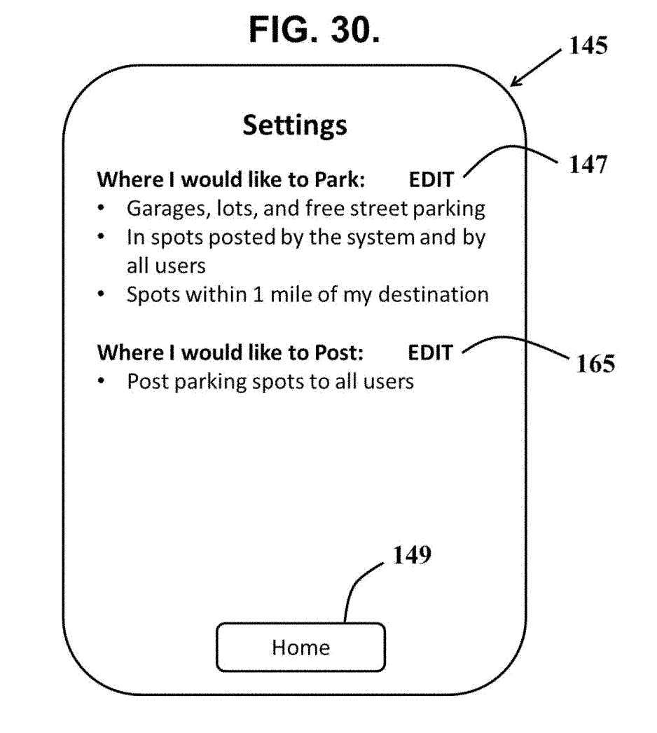

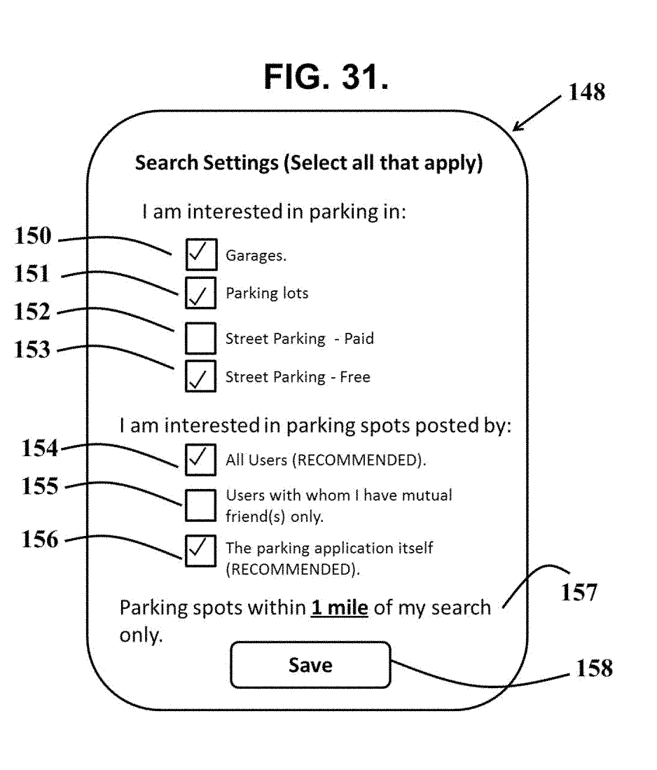

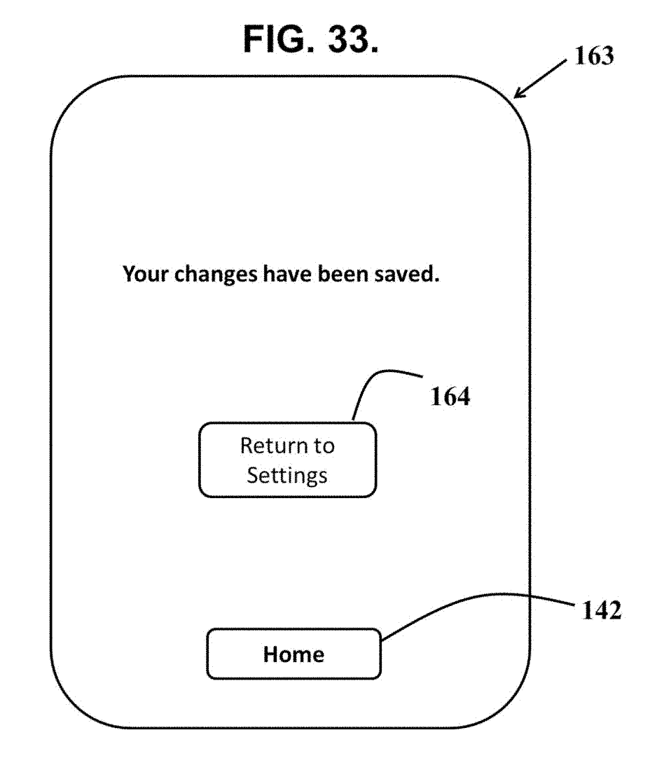

Note that various settings can be changed by the user. When the Settings button 143 is clicked on the Home Screen 16 as shown in FIG. 3, then the user's smartphone will display the Settings page 145 as shown in FIG. 30. When the first Edit button 147 is clicked, then the user's smartphone displays a Search Settings screen 148 as shown in FIG. 31. (Note another way to arrive at this screen: when the user clicks the ‘Change Search Settings’ link 146 of the Find Parking Screen 42, shown in FIG. 8, the user's smartphone will also display the Search Settings screen 148 as shown in FIG. 31.). Here on the Search Settings Screen 148 of FIG. 31 the user may select from one or more check boxes to answer the screen prompt of where the user is interested in parking: Garages 150, Parking lots 151, Street Parking Paid 152, and Street Parking Free 153. The user may also select check boxes to answer the prompt of parking spots the user is interested in, including All Users 154, Users with Mutual Friends 155, and The Parking Application itself 156. The spots available from the application itself could include spots that are not necessarily posted by specific users but that the parking program has acquired knowledge of from other sources, such as for instance, paid garages, lots, etc., and added to the data store 3. The screen could also include a selection on the mileage distance surrounding the search address that the user would like a search to include when displaying parking spots 157. This can be updated by clicking the underlined text and filling in the appropriate number. Once the user has finished editing the settings on this page 148, and the user selects the Save button 158, then the user's smartphone displays the Settings Saved page 163, as shown in FIG. 33.

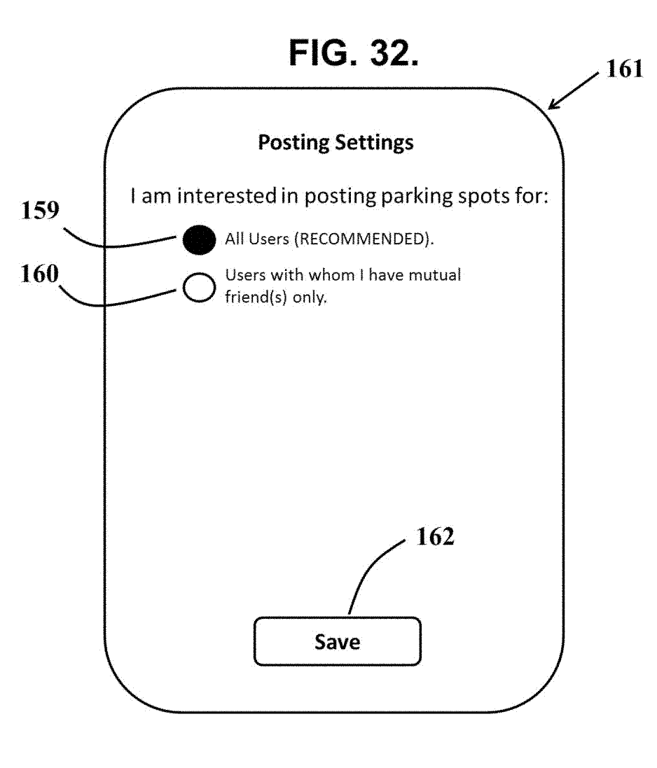

Returning again to the Settings Screen 145 as shown in FIG. 30, when the user clicks the second Edit button 165, the user's smartphone 6 displays the Posting Settings page 161, as shown in FIG. 32. (Note another way of arriving at this screen: when the Edit Posting Settings link 144 is clicked on the Spot Details screen 82 of FIG. 17, then the user's smartphone will also display the Posting Settings page 161 of FIG. 32). On the Posting Settings page 161 the user has the choice of selecting one of two radio buttons to answer the prompt at the top of the screen describing who the user is interested in posting parking spots for: All Users 159, or Users with Mutual Friends 160. Note that alternate embodiments may have further choices. Once the user has made this selection of button 159 or button 160 and clicked the Save button 162, then the user's smartphone 6 will display the Settings Saved page 163, as shown in FIG. 33. Here the page will inform the user that the changes have been saved. The user may click the Return to Settings button 164, which would cause the user's smartphone to display the Settings page 145 as shown in FIG. 30. Alternatively, the user may click the Home button 142 on the Settings Saved page 163 as shown in FIG. 33, which would cause the user's smartphone 6 to display the Home page 16, as shown in FIG. 3.

Note that when a user posts a parking spot, this information is communicated to the web server 2. Similarly, when a user books a parking spot, this information is communicated to the web server 2. Furthermore the information related to the user's online status including GPS updates and direction of travel on the day of a parking transaction may be forwarded to other users. In the real-time route page 106 of FIG. 26, for instance, real-time GPS updates may be relayed from the web server 2. Note also that data from the data store 3 could also be stored in a cloud as is well known in the art.

Embodiments of the present invention could include self-driving vehicles, where users could be passengers in such cars, owners of such cars, or the self-driving vehicles could be the users of the system themselves. In one embodiment, the user interface screen could be part of the vehicle itself and GPS information collected by way of the vehicle itself, rather than from a smartphone.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the scope of the invention, as defined by the claims.

What is claimed is:

1. A method of coordinating the parking activities of a plurality of users, the method comprising the steps of:
collecting profile information from a plurality of users and storing the information in a database, the profile information comprising a name of user and a vehicle description of at least one vehicle per user;
collecting time, date, and location information of available parking spots from a plurality of users and storing the information in a database;
collecting time, date, and location information of filled parking spots from a plurality of users and storing the information in a database;
collecting time, date, and location information of booked parking spots from a plurality of users and storing the information in a database;
receiving indicia from a first user among said plurality of users indicating that the first user expects to be vacating a parking spot;
receiving time and date information from the first user, the time and date information describing the expected time and date when the first user intends to vacate said parking spot;
receiving location information from the first user, the location information describing the location of the first user's said parking spot;
receiving indicia from a second user among said plurality of users that the second user is active;
receiving indicia from the second user that the second user is interested in finding a parking spot;
receiving indicia from the second user that the second user is interested in finding a parking spot within the time frame and vicinity of the first user's parking spot;
displaying a map to the second user, the map indicating the first user's parking spot location and displaying the time and date of the expected vacancy of the first user's parking spot;
facilitating a channel of communication between the first user and the second user;
sending profile information collected from the second user to the first user;
sending profile information collected from the first user to the second user;
receiving an input command from the second user;
displaying profile information and parking spot information collected from the first user for the second user in response to the input command received from the second user;
receiving an input command from the first user;
displaying profile information collected from the second user for the first user in response to the input command received from the first user;
enabling the second user to communicate an interest in said parking spot to the first user;
receiving a second input command from the second user;
sending information from the second user to the first user indicating the second user's interest in the first user's parking spot;
displaying information collected from the second user for the first user indicating the second user's interest in the first user's parking spot in response to the second input command;
enabling the first user and second user to agree to a parking transaction;
enabling the first user and second user to trade, the trade comprising an exchange, where the exchange comprises the first user transferring said parking spot to the second user in exchange for something of value to the first user;
receiving regular first user GPS position updates on the date of said parking exchange;
receiving regular second user GPS position updates on the date of said parking exchange;
determining the second user's direction of travel on the date of said parking exchange based on the regular second user GPS position updates;
determining the first user's direction of travel based on regular GPS position updates on the date of said parking exchange;
sending profile information collected from the second user and one or more second user GPS position updates to the first user; and
sending profile information collected from the first user and one or more first user GPS position updates to the second user.

2. The method of claim 1, further comprising the steps of:
receiving a time range from the second user, describing the time range in which the second user intends to arrive at the first user's parking spot; and
receiving a time range from the first user, describing the length of time the first user is willing to wait at the first user's parking spot.

3. The method of claim 1, wherein said something of value comprises points used within the parking system, where points can be used in exchange for parking spots.

4. The method of claim 1, wherein said something of value comprises actual currency.

5. The method of claim 1, wherein said something of value comprises electronic currency.

6. The method of claim 1, wherein said something of value comprises credit card payments.

7. The method of claim 1, wherein said something of value comprises any form of payment available now or in the future.

8. The method of claim 1, further comprising the steps of:
identifying locations where parking is in high demand;
identifying times when parking is in high demand; and
adjusting pricing or point values of available parking spots accordingly.

9. The method of claim 1, further comprising the step of:
receiving a message from the first user and transmitting the message to the second user.

10. The method of claim 1, further comprising the step of:
receiving a message from the second user and transmitting the message to the first user.

11. The method of claim 1, wherein the profile information of a user also comprises a friends list from within the system, where the friends list is a list of contacts of the user.

12. The method of claim 1, wherein the profile information of a user also comprises a friends list from an external social networking site.

13. The method of claim 1, wherein the step of sending profile information of the first user to the second user further comprises:
displaying mutual friends between the first user and the second user.

14. The method of claim 1, wherein the step of sending profile information of the second user to the first user further comprises:
displaying mutual friends between the first user and the second user.

15. The method of claim 1, wherein the users comprise drivers of vehicles.

16. The method of claim 1, wherein the users comprise passengers of vehicles.

17. The method of claim 1, wherein the users comprise drivers of vehicles and passengers of vehicles.

18. The method of claim 1, wherein the users comprise owners of vehicles.

19. The method of claim 1, wherein the users comprise self-driving vehicles.

20. The method of claim 1, wherein the users comprise:
(a) drivers of vehicles;
(b) passengers of vehicles;
(c) owners of vehicles;
(d) lessors of vehicles;
(e) lessees of vehicles; and
(f) renters of vehicles.

21. The method of claim 1, wherein the users comprise:
(a) drivers of vehicles;
(b) passengers of vehicles;
(c) owners of vehicles;
(d) lessors of vehicles;
(e) lessees of vehicles;
(f) renters of vehicles; and
(g) computers or computer programs that run self-driving vehicles.

22. The method of claim 1, wherein the step of sending profile information and one or more GPS position updates of the second user to the first user further comprises:
superimposing a graphical representation of the route information and location of the second user's vehicle on a map displayed to the first user.

23. The method of claim 1, wherein the step of sending profile information and one or more GPS position updates of the first user to the second user further comprises:
superimposing a graphical representation of the location of the first user's vehicle on a map displayed to the second user.

24. The method of claim 1, further comprising the step of:
directing the second user through a route to the location of the first user.

25. The method of claim 1, wherein the profile information includes the number of points a user possesses in his or her account, where the points can be used to purchase parking spots.

26. The method of claim 1, wherein the users subscribe to the parking system.

27. The method of claim 1, wherein the method further comprises the step of:
facilitating GPS tracking and communication between the users through the users' smartphones.

28. The method of claim 1, wherein the method further comprises the step of:
facilitating GPS tracking and communication between the users through the users' vehicles.

29. The method of claim 1, wherein the vehicle used by the user is a self-driving vehicle.

30. A parking system, comprising:
a database comprising:
(a) available parking spots;
(b) parking spots occupied by vehicles;
(c) parking spots advertised by users;
(d) parking spot vicinities requested by users;
(e) a location, date and time frame of a user's expected departure from a parking spot;
(f) a location, date and time frame of a user's expected arrival at a parking spot;
(g) real-time location and route information of users through GPS position updates;
(h) profile information of users, the profile information comprising name and vehicle description;
(i) a medium of communication between users; and
(j) a medium of exchange during a transaction between users;
thereby enabling a user to be equipped with sufficient information to book a parking spot, or to advertise a parking spot to other users, and to successfully complete a transaction of exchange.

31. The parking system according to claim 30, wherein the database also comprises:
(a) friend lists of users; and
(b) mutual friends of a plurality of users.

32. The parking system according to claim 30, wherein the database also comprises a link between a user's parking system account and said user's external social media account.

33. The parking system according to claim 30, wherein the medium of exchange during a transaction comprises a form of currency in exchange for parking spots.

34. The parking system according to claim 30, wherein the medium of exchange during a transaction comprises an electronic currency such as points in a user account that can be used to acquire other parking spots within the system.

35. The parking system according to claim 30, wherein the medium of exchange during a transaction comprises any form of payment, including future forms of payment.

36. The parking system according to claim 30, wherein the database also comprises subscription accounts for users.

37. The parking system according to claim 30, wherein the database also comprises ratings of users as determined by other users.

38. The parking system according to claim 30, wherein the database also comprises ratings of users as determined by user activity in the parking system.

39. The parking system according to claim 30, wherein the database also comprises parking restrictions on streets.

40. The parking system according to claim 30, wherein users use a system containing GPS through said users' mobile phones.

41. The parking system according to claim 30, wherein users use a system containing GPS through said users' vehicles.

42. The parking system according to claim 30, wherein the system is configured to direct a user through a route in the streets using GPS to an available parking spot.

43. The parking system according to claim 30, wherein the system and users communicate through the vehicle itself, where the vehicle contains an interface screen and GPS capability.

44. The parking system according to claim 30, wherein the vehicle used by the user is a self-driving vehicle.

45. The parking system according to claim 30, wherein the parking system communicates through the vehicle itself, where the vehicle contains an interface screen and GPS capability and is a self-driving vehicle.
